(19) United States
(12) Patent Application Publication
(10) Pub. No.: US 2004/0244608 A1
(43) Pub. Date: Dec. 9, 2004

(54) Method for making a fibre, especially a board web, and concept for making a fibre web, especially a board web

(76) Inventors: Matti Lares, Tuusula (FI); Kari Hasanen, Kerava (FI)

Correspondence Address: STIENNON & STIENNON, 612 W. MAIN ST., SUITE 201, P.O. BOX 1667, MADISON, WI, 53701-1667, US

(21) Appl. No.: 10/489,554

(22) PCT Filed: Aug. 9, 2002
(86) PCT No.: PCT/FI02/00659

(30) Foreign Application Priority Data
Sep. 12, 2001 (FI) 20011799

(51) Int. Cl. D21G 1/00; D21H 19/00; B30B 11/22; D21F 11/00; D21H 11/00; D21F 13/00; D21H 13/00; D21H 15/00; D21H 17/00; D21H 21/00; D21H 23/00; D21H 25/00; D21H 27/00; D21J 1/00; D21J 7/00

(52) U.S. Cl. 100/41; 162/206; 162/205; 162/135; 162/361

(57) ABSTRACT

A method for making a fibre web, especially aboard web. The fibre web (W) is pre-calendered in a long-nip calender (11; 21), which replaces the Yankee cylinder. The invention also concerns a concept for making a fibre web, especially board. The concept includes a long-nip calender (11; 21) for pre-calendering the fibre web and to replace the Yankee cylinder.

### CROSS REFERENCES TO RELATED APPLICATIONS

This application is a U.S. National Stage application of International Application No. PCT/FI02/00659, filed Aug. 9, 2002, and claims priority on Finnish Application No. 20011799, Filed Sep. 12, 2001.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns a method for making a fibre web, especially a board web.

The invention also concerns a concept for making a fibre web, especially a board web.

With respect to the prior art, reference may be made to WO 0070146, which describes a method and an apparatus for producing a paper or board web, and to WO 9967462, which describes a method and an apparatus for calendaring paper or board before and after coating.

Known in the state of the art are various methods for making a fibre web, especially board, as well as various concepts for making a fibre web, especially board. The Yankee cylinder has been a problem in making board, which cylinder has been used for drying the board and for which a replacing alternative has been sought, because the Yankee cylinder has a limited drying capacity, which limits the speed of the board machine. The surface of the board web becomes smooth in connection with Yankee drying. The smooth surface is suitable for coating.

The objective of this invention is to bring about such a method and such a concept for making a fibre web, especially board, wherein no Yankee cylinder is needed.

The invention is based on utilization of long-nip calendering, which is known as such. In long-nip calendering it is possible to use shoe-press technology or roller/belt technology. In shoe calendering the known shoe press technology known from the press section is utilized, wherein the shoe roller includes a shoe, loading elements, a lubrication oil system and a belt. The thermo roller is technology known from soft calendering and it can be a roller heated by water, steam, oil or induction. The nip width is determined by the shoe width, and the shoe nip allows making the nip of a standard width independently of the loading, roller diameters and belt characteristics. This makes possible optimizing of the dwell time of variables important in calendering and optimizing of the nip pressure independently of each other.

In belt calendering again a water, steam, oil or induction heated roller is used as well as belt circulation and a backing roller, which may be either a hard roller or a soft roller. The belt circulates by way of the backing roller and guiding/tensioning rollers, and the simple structure of the belt circulation also allows modernizing of old machine calendars and soft calendars for use in belt calendering.

When using long-nip calendering to replace the Yankee cylinder in making board, the ability to profile the thickness is also required, which is not very good as such in long-nip calendering, so it is a not necessary additional objective of the invention also to bring about a method and a concept, in one advantageous application of which good thickness profiling is also brought about in the pre-calendering carried out in connection with preparation of the calendering.

In order to achieve the objectives mentioned above and those emerging hereinafter, the method according to the invention is mainly characterized in that the fibre web is pre-calendered in a long-nip calender, which replaces the Yankee cylinder.

### SUMMARY OF THE INVENTION

The concept according to the invention is mainly characterized in that the concept includes a long-nip calender for pre-calendering of the fibre web and to replace the Yankee cylinder.

The method and concept according to the invention for making a fibre web, especially board, are formed by two calendering steps: pre-calendering by a long-nip calender and the actual calendering by a profiling calender, for example, either a soft calender or a machine calender. According to the invention, the Yankee cylinder is thus replaced by pre-calendering carried out by a long-nip calender, whereby the board web is dried e.g. by ordinary drying cylinders and the surface of the board web is made smooth in the long-nip calender.

According to an advantageous application of the invention, the production line first includes a long-nip calender functioning as a pre-calender, whereupon surface sizing of the fibre web is performed, thereafter drying of the fibre web and calendering with a profiling calender and then coating. According to another advantageous application of the invention, pre-calendering by a long-nip calender is used, then a profiling calender and next coating is performed.

With the method and concept according to the invention profiling of the fibre web is achieved in the CD direction. A uniform CD profile is important e.g. for reeling of the board/paper.

According to an additional advantageous feature of the invention, the long-nip calender functioning as a pre-calender is profiled by a profiling induction heating device, whereby perpendicular profiling of the fibre web is achieved. The long-nip calender may include a thermo roller and a symbelt roller including an elastomeric belt, for example, a urethane or rubber belt. If desired, a metal belt may also be placed above the elastomeric belt or instead of this. Instead of the symbelt roller, the belt may also be mounted around the sym roller and several tube rollers to form a so-called belt calender. When profiling the fibre web perpendicularly by using profiling induction from the hottest spot, the paper is calendered more, whereby the web thickness is reduced, but the gloss and smoothness are also increased. Any resulting gloss variation in the CD direction is covered when the web is coated. The calender according to the invention provided with profiling induction may also work as a final calender with such grades where gloss variation in the CD direction is not harmful. As the diameter of the thermo roller is always big in a long-nip calender, even a small difference in the temperature will enlarge the roller diameter, which along with a long dwell time and a higher surface temperature will efficiently profile the fibre in the perpendicular direction.

In the following, the invention will be described in greater detail with reference to the figures shown in the appended drawing, but the intention is not in any way to limit the invention to the details therein.

### BRIEF DESCRIPTION OF THE DRAWINGS

FIG. 1 is a schematic view of an application of the invention having a long-nip calender, a surface-sizing unit, a drying unit, a profiling calender and coating.

FIG. 2 is a schematic view of another application of the invention having a long-nip calender, a profiling calender and a coating unit.

FIGS. 3A-3B show applications for a long-nip calender, which can be used for profiling the fibre web in the perpendicular direction.

### DESCRIPTION OF THE PREFERRED EMBODIMENTS

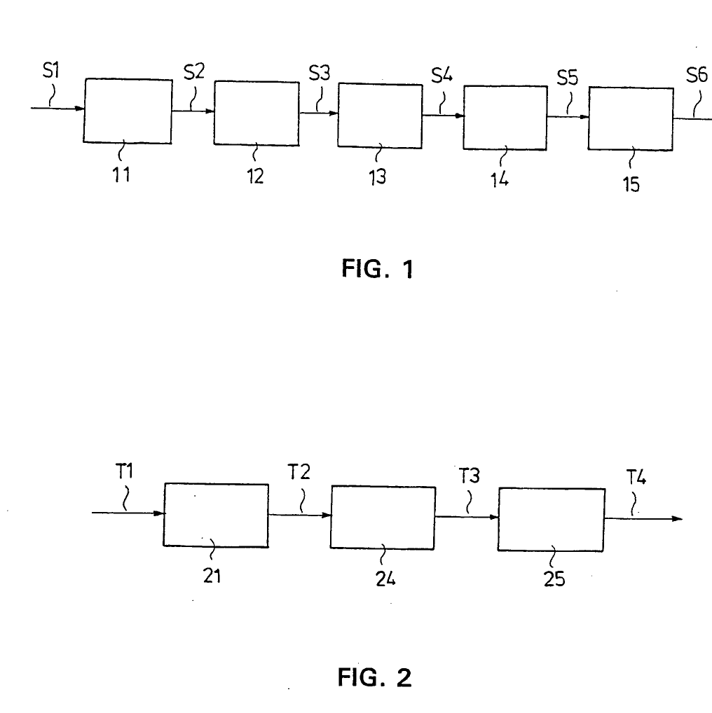

In the application according to FIG. 1, the fibre web is taken from the previous processing step indicated by arrow S1 to a long-nip calender 11 functioning as a pre-calender, whence the web is taken further as shown by arrow S2 to a surface-sizing unit 12, whereupon follows as shown by arrow S3 a drying unit 13 and as shown by arrow S4 then a calender 14 profiling in the CD direction. After the profiling calender 14 the fibre web is taken as shown by arrow S5 to a coating unit 15, from which it is taken further to the following processing steps as shown by arrow S6.

In the schematic application of the concept shown in FIG. 2, the fibre web is taken from the previous processing step as shown by arrow T1 to a long-nip calender 21 functioning as a pre-calender, from which it is taken as shown by arrow T2 to a calender 24 profiling in the CD direction, which as shown by arrow T3 is followed by a coating unit 25, from which the web is taken further as shown by arrow T4 to the following processing step.

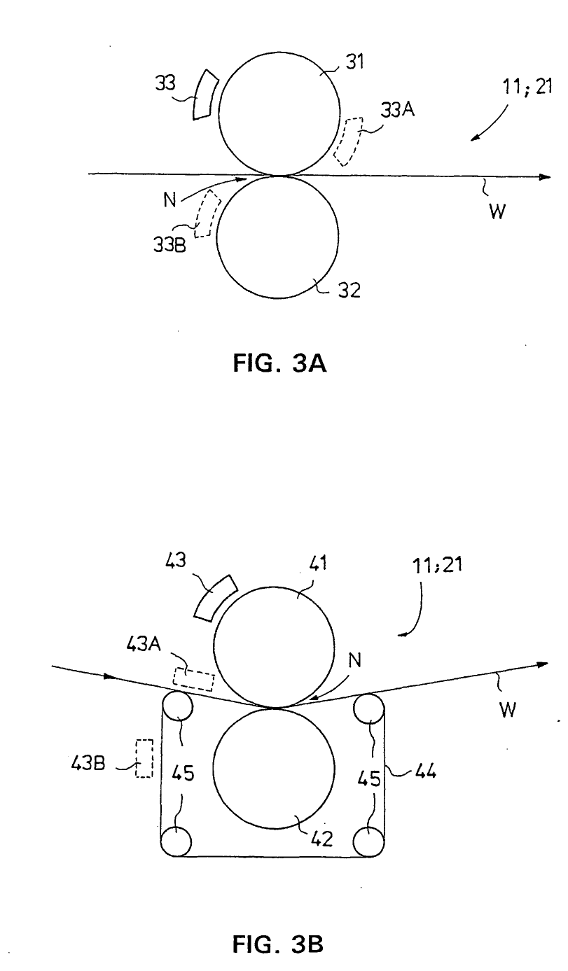

In the application shown in FIG. 3A, the fibre web is also taken to a long-nip calender 11; 21 profiling in the perpendicular direction; where the calendering nip is formed in between a thermo roller 31 and its backing roller 32, for example, a symbelt-shoe roller. An induction heating unit 33 profiling the fibre web W in the perpendicular direction is placed in connection with the thermo roller 31. Alternatively, the induction heating unit may be placed e.g. at the locations 33A shown by dashed lines, which are also close to the thermo roller, or at 33B in connection with backing roller 32.

FIG. 3B shows another schematic application for a long-nip calender 11; 21 profiling the fibre W in the perpendicular direction, wherein the calendering nip N is formed in between the thermo roller 41 and its backing roller 42, which is e.g. a symbelt-shoe roller, and around the symbelt-shoe roller 42 a belt 44 is located to travel, which belt may be an elastomeric belt or a metal belt. The tensioning and guiding rollers of belt 44 are indicated by reference number 45. An induction heating unit 43 profiling the fibre web W is located in connection with the thermo roller. Alternatively, it may be located at positions 43A, 43B indicated by dashed lines.

The induction heating unit 33, 43 (33A, 33B; 43A, 43B) extends across the essential cross-directional width of the fibre web W, and when the web W is heated, the web is calendered more by its mediating action, whereby the web thickness is reduced.

1-18. (cancelled)

19. A method for making a board fibre web comprising:
replacing a Yankee cylinder with a long-nip calender; and
pre-calendering the web in the long-nip calender.

20. A method for making a fibre web comprising the steps of:
taking a fiber web from a previous processing step and pre-calendering the fiber web in a long-nip calender;
sizing the web on a surface with a sizing unit;
drying the fiber web in a drying unit;
profiling the fiber web in a profiling calender; and
coating the fiber web in a coating unit.

21. The method of claim 20 wherein the step of pre-calendering the fiber web in a long-nip calender further comprises profiling the fiber web in said long-nip calender by a profiling induction heating device, to profile the fiber web in a direction perpendicular to the web.

22. The method of claim 21, wherein the profiling induction heating device heats the web at selected spots, whereby the selected spots are calendered more and the thickness of the fiber web is reduced at the selected spots.

23. The method of claim 20 wherein the long-nip calender is formed by a thermo roller and a roller including an elastomeric belt.

24. The method of claim 20, wherein the long-nip calender is formed by a thermo roller and a roller including a metal belt.

25. The method of claim 20, wherein the long-nip calender is formed by a thermo roller and a belt formed around several tube rollers.

26. The method of claim 20, wherein the long-nip calender has a backing roll having a diameter and the diameter is profiled by a profiling induction heating device wherein the temperature difference enlarges the diameter of said backing roll.

27. A method for making a fibre web comprising the steps of:
taking a fiber web from a previous processing step and pre-calendering the fiber web in a long-nip calender;
profiling in a cross machine direction the fiber web in a profiling calender; and
coating the fiber web in a coating unit.

28. The method of claim 27 wherein the step of pre-calendering the fiber web in a long-nip calender further comprises profiling the fiber web in said long-nip calender by a profiling induction heating device, to profile the fiber web in a direction perpendicular to the web.

29. The method of claim 28, wherein the profiling induction heating device heats the web at selected spots, whereby the selected spots are calendered more and the thickness of the fiber web is reduced at the selected spots.

30. The method of claim 27 wherein the long-nip calender is formed by a thermo roller and a roller including an elastomeric belt.

31. The method of claim 27 wherein the long-nip calender is formed by a thermo roller and a roller including a metal belt.

32. The method of claim 27, wherein the long-nip calender is formed by a thermo roller and a belt formed around several tube rollers.

33. The method of claim 27, wherein in the long-nip calender has a backing roll having a diameter and the diameter is profiled by a profiling induction heating device, wherein the temperature difference enlarges the diameter said backing roller.

34. An apparatus for making a board fiber web, comprising:
a long-nip pre-calender;
a surface-sizing equipment;
a drying unit;
a cross machine direction profiling calender; and
a coating unit, wherein the board fiber web is arranged to pass through each of said long-nip pre-calender, said surface-sizing equipment, said drying unit, said profiling calender and said coating unit in the forgoing order.

35. The apparatus for making a board fiber web of claim 34 wherein the long-nip pre-calender is formed by a thermo roller and a roller including an elastomeric belt.

36. The apparatus for making a board fiber web of claim 34 wherein the long-nip pre-calender is formed by a thermo roller and a roller including a metal belt.

37. The apparatus for making a board fiber web 34 wherein the long-nip pre-calender is formed by a thermo roller and a belt formed around several tube rollers.

38. The apparatus for making a board fiber web of claim 34 wherein the long-nip calender includes profiling induction heating equipment for profiling the fiber web in the perpendicular direction.

39. The apparatus for making a board fiber web of claim 34 wherein the profiling calender profiles in the CD direction of the fiber web.

40. An apparatus for making a board fiber web, comprising:
a long-nip pre-calender;
a cross machine direction profiling calender; and
a coating unit, wherein the board fiber web is arranged to pass through each of said long-nip pre-calender, said profiling calender and said coating unit in the forgoing order.

41. The apparatus for making a board fiber web of claim 40 wherein the long-nip pre-calender is formed by a thermo roller and a roller including an elastomeric belt.

42. The apparatus for making a board fiber web of claim 40 wherein the long-nip pre-calender is formed by a thermo roller and a roller including a metal belt.

43. The apparatus for making a board fiber web 40 wherein the long-nip pre-calender is formed by a thermo roller and a belt formed around several tube rollers.

44. The apparatus for making a board fiber web of claim 40 wherein the long-nip calender includes profiling induction heating equipment for profiling the fiber web in the perpendicular direction.

45. The apparatus for making a board fiber web of claim 40 wherein the profiling calender profiles in the CD direction of the fiber web.
